(19) United States
(12) Patent Application Publication
(10) Pub. No.: US 2026/0004064 A1
(43) Pub. Date: Jan. 1, 2026

(54) Machine Learning Based Rules Compiler for Part-Of-Speech Tagging

(71) Applicant: Open Text Corporation, Waterloo (CA)

(72) Inventors: Geoffrey Michael Obbard, Waterloo (CA); Alicia Maria Ferraro, Waterloo (CA)

(21) Appl. No.: 18/755,364

(22) Filed: Jun. 26, 2024

(51) Int. Cl. G06F 40/253; G06F 8/35; G06F 40/284; G06F 40/55

(52) U.S. Cl. CPC G06F 40/253; G06F 8/35; G06F 40/284; G06F 40/55

(57) ABSTRACT

A computer-implemented method for a machine learning based rules compiler, the method comprising receiving machine learning generated ripple down rules, the ripple down rules comprising exception rules for tags in a tag set, the exception rules comprising tag string comparisons. The method further comprises compiling the ripple down rules into optimized computer code. Compiling the rules into computer code further comprises generating an enumeration statement for an enumeration containing the tag set, translating the exception rules for each tag in the tag set into if-else statements for a respective tag, including replacing the tag string comparisons with the enumeration; and generating a switch case statement for a current tag, the switch case statement having cases corresponding the tags in the tag set and including the if-else statements for the respective tag. The optimized computer code comprises the enumeration statement and the switch case statement.

### TECHNICAL FIELD

This disclosure relates to part-of-speech tagging. Even more particularly, embodiments of the present disclosure relate to the generation of optimized code for a part-of-speech tagger.

### BACKGROUND

Part-of-speech (POS) tagging is used in many areas of computer science including, but not limited to, natural language processing (NLP), indexing documents for search, and processing search queries.

Historically, computer-implemented POS tagging has taken one of two main approaches. The first approach uses a hand-coded set of rules implemented by a developer directly in the native language of the application. The second approach uses machine-learning to dynamically process text at run time.

The advantage of a hand-coded approach is that it can be relatively efficient at run-time. The disadvantage of the hand-coded approach is that the code required to implement the rules can be very large and complicated to maintain, and requires expertise in the human language (English, French, etc.) to tag.

The advantage of machine learning approaches is that they require little expertise in the human language, as a machine learning model can be trained to recognize parts of speech using labeled training data. Machine learning taggers make it relatively easy for software developers to train a set of rules on a human language they know little about. The disadvantage of machine learning taggers is that they apply the trained machine learning model to dynamically interpret rules at run-time, which is resource intensive and slow.

Therefore, improved mechanisms for providing part-of-speech tagging are desired.

### SUMMARY

Embodiments of the present disclosure provide systems and methods for generating code for a machine learning-based rules part of speech tagger.

One embodiment comprises a method for generating part of speech tagger code, the method comprising processing a corpus of documents using a machine learning rules generator to generate ripple down rules for part-of-speech tagging for a language, the ripple down rules comprising exception rules for tags in a tag set, the exception rules comprising tag string comparisons. The method further comprises compiling the ripple down rules into optimized computer code. Compiling the ripple down rules into optimized computer code further comprises: generating an enumeration statement for an enumeration containing the tag set; translating the exception rules for each tag in the tag set into if-else statements for the tag, translating the exception rules further comprising replacing the tag string comparisons with the enumeration; and generating a switch case statement for a current tag, the switch case statement having a plurality of cases, each case in the plurality of cases corresponding to a respective tag from the tag set and including the if-else statements for the respective tag, wherein the optimized computer code comprises the enumeration statement and the switch case statement.

Embodiments may include receiving a plurality of tokens generated from the document; executing the optimized computer code to assign part-of-speech tags to the plurality of tokens; performing a lemmatization of the plurality of tokens using the part-of-speech tags to determine root words for the plurality of tokens; and indexing the document using the root words.

Embodiments may comprise processing a search query, wherein processing the search query comprises: receiving a plurality of tokens generated from the search query; executing the optimized computer code to assign part-of-speech tags to the plurality of tokens; performing a lemmatization of the plurality of tokens using the part-of-speech tags to determine root words for the plurality of tokens; and searching an index using the root words.

Embodiments can provide a combination of optimizations that allow the Java compiler to write code that changes the complexity of the initial tag dispatch from O(T) in the number of distinct tags for the interpreted approach (roughly ˜30 tags for the Penn Treebank tag-set), to O(log (T)) for the switch statement on strings (via the JVM lookupswitch op-code), to O(1) (constant time) for the switch statement on an enumeration (via the JVM tableswitch op-code).

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 is a diagrammatic representation of one embodiment of a machine learning-based rules part-of-speech (MLRPOS) tagger generator.

FIG. 2 is a diagrammatic representation of one embodiment of a learning process for an MLRPOS tagging rules learner.

FIG. 3A, FIG. 3B, FIG. 3C, FIG. 3D, FIG. 3E, FIG. 3F, FIG. 3G are diagrammatic representations of portion of SCRDR tree.

FIG. 4 depicts on example embodiments of ripple down rules.

FIG. 5A, FIG. 5B, and FIG. 5C illustrate one embodiment of portions of code generated from ripple down rules.

FIG. 6 is a flowchart of one embodiment of a method of generating POS tagger code.

FIG. 7 is a flow chart of one embodiment of a of indexing a document.

FIG. 8 is a flowchart illustrating one embodiment of a method for searching a document.

FIG. 9 is a diagrammatic representation of one embodiment of a computer system.

### DETAILED DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

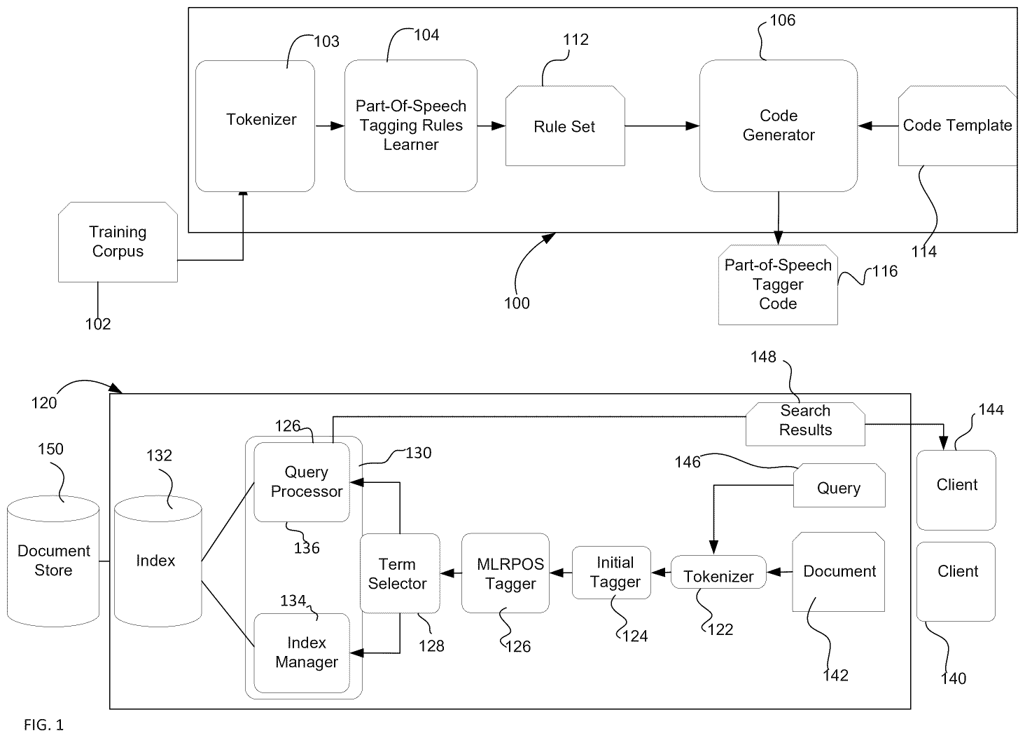

FIG. 1 is a diagrammatic representation of one embodiment of a machine learning-based rules part-of-speech (MLRPOS) tagger generator 100 and a search system 120. MLRPOS tagger generator 100 generates MLRPOS tagger code 116 which embodies rules learned through the application of machine learning. The MLRPOS tagger code can be deployed to various systems to provide MLRPOS tagging. In FIG. 1, for example, MLRPOS tagger 126 represents a deployed instance of MLRPOS tagger code 116.

MLRPOS tagger code 116, and hence MLRPOS tagger 126, comprises code that embodies rules learned through machine learning. Embodiments provide similar advantages as traditional machine learning approaches over hand coded taggers because they can leverage rules learned by applying machine learning to tagged training data without requiring a developer to have expertise in the human language. Further, embodiments can provide advantages over hand coded taggers by automatically generating the tagger code.

Embodiments can also provide advantages over traditional machine learning approaches. MLRPOS tagger 126, according to one embodiment, is a non-machine learning (non-ML) MLRPOS tagger that does not implement or use a machine learning algorithm to dynamically interpret tagging rules at run-time (i.e., when performing POS tagging). Thus, the non-ML MLRPOS tagger 126 is not as resource intensive and can more quickly tag documents compared to taggers that use machine learning models to interpret rules dynamically at run time.

In the embodiment illustrated, MLRPOS tagger generator 100 comprises a tokenizer 103, a machine learning based rule part-of-speech (MLRPOS) tagging rules learner 104 (learner 104), and a MLRPOS tagger code generator 106 (generator 106). Tokenizer 103 tokenizes a corpus of text 102 (e.g., a corpus of documents) to tokenize the text into a sequence of tokens for input to a machine learning based rule part-of-speech (MLRPOS) tagging rules learner 104 (learner 104). The tokens correspond to words, punctuation or other units of text based on the tokenization model used.

Learner 104 applies machine learning to the corpus of text 102 to learn an MLRPOS tagging rule set 112. Learner 104, according to one embodiment, is operable to output MLRPOS rule set 112 using a rules format that can be easily mapped to a programming language. Non-limiting examples of using machine learning to learn POS tagging rules are described in Brill, “A Simple Rule-Based Part of Speech Tagger,” Proceedings of the third conference on Applied natural language processing. Association for Computational Linguistics, USA, pp. 152-155, 1992, which is hereby fully incorporated herein by reference for all purposes. In more particular embodiments, learner 104 applies machine learning to learn ripple down rules (RDR) for POS tagging. As such, in some embodiments, learner 104 is an RDR POS tagger (RDRPOSTagger). Non-limiting examples of learning RDR for POS tagging are described in Nguyen et al., “RDRPOSTagger: A Ripple Down Rules-based Part-Of-Speech Tagger,” Proceedings of the Demonstrations at the 14th Conference of the European Chapter of the Association for Computational Linguistics, pages 17-20, Gothenburg, Sweden, Apr. 26-30, 2014, and Nguyen et al. “Ripple Down Rules for Part-of-Speech Tagging,” In Proc. of 12th CICLing—Volume Part I, pages 190-201 (2011), which are hereby fully incorporated by reference herein.

Generator 106 processes MLRPOS tagging rule set 112 to generate MLRPOS code in a desired language. Generator 106 may insert the generated MLRPOS code in a template 114 to output MLRPOS tagger code 116 that embodies the MLRPOS rule set 112. In one embodiment, generator 106 translates MLRPOS tagging rule set 112 into computer code, such as Java code.

Turning to search system 120, search system 120 includes a tokenizer 122, an initial tagger 124, MLRPOS tagger 126, a term selector 128, and a search engine 130 that manages and uses an index 132 for searching for documents in document store 150. Search engine 130 comprises an index manager 134 and a query processor 136. MLRPOS tagger 126 is an instance of MLRPOS tagger code 116 generated by generator 106.

Tokenizer 122 tokenizes text (e.g., documents) (e.g., on a per word basis) and passes a token stream to initial tagger 126, which tags the tokens with initial POS tags. Tokenizer 122, in some embodiments, uses the same tokenization model as tokenizer 103.

Initial tagger 124 is a lightweight tagger with a limited rules set to assign initial POS tags to the text tokens. According to one embodiment, initial tagger 124 uses the same POS tagging rules as an initial tagger of learner 104. The sequence of token/initial tag pair stream is passed to MLRPOS tagger 126 which applies the ML-based POS tagging rules learned by learner 104 to the token/initial tag pairs to assign final POS tags to the tokens. The sequence of token/final POS tags is passed to term selector 128.

Term selector 128 applies rules to select terms for inclusion in search queries or indexing requests. According to one embodiment, term selector 128 performs lemmatization using the final POS tags to determine a set of root words from the token/final POS tag pairs and generates a search query or indexing request that includes the root words.

Index manager 134 updates index 132 to index documents using terms provided by term selector 128. Query processor 136 uses index 132 to identify documents matching the search criteria provided by term selector 128.

In operation, search system 120 receives a request from client 140 to index a document 142 stored or to be stored in document store 150. Tokenizer 122 tokenizes the document (e.g., on a per word basis) and passes a document token stream to initial tagger 126, which tags the document tokens with initial POS tags.

The sequence of document word token/initial tag pairs is passed to MLRPOS tagger 126 which applies the ML-based POS tagging rules learned by learner 104 to the document token/initial tag pairs to assign final POS tags to the tokens. The sequence of token/final POS tags is passed to term selector 128.

Term selector 128 applies rules to select terms for inclusion in an indexing request to index document 142. According to one embodiment, term selector 128 performs lemmatization using the final POS tags to determine a set of root words from the token/final POS tag pairs and generates an indexing request to index manager 134 where the indexing request includes the root words. Index manager 134 updates index 132 to index document 142 using the words in the indexing request from term selector 128. For example, index manager 134 may thus index document 142 using the root words.

Further, in the embodiment illustrated, search system 120 receives a search query 146 from client 144 to search for documents in a document store. Tokenizer 122 tokenizes the search query (e.g., on a per word basis) and passes a search query token stream to initial tagger 126, which tags the search query tokens with initial POS tags. MLRPOS tagger 126 applies the ML-based POS tagging rules learned by learner 104 to the search query token/initial tag pairs to assign final POS tags to the search query tokens. The search query token/final POS pairs are passed to term selector 128, which may apply various techniques to select terms for inclusion in a modified search query. According to one embodiment, term selector 128 performs lemmatization using the final POS tags to determine a set of root words from the search query token/final POS tag pairs and generates a modified search query to search engine 130 that includes the root words. Query processor 136 uses index 132 to identify documents matching the search criteria from the modified search query and returns a search result 148 identifying documents from document store 150 that match the search criteria.

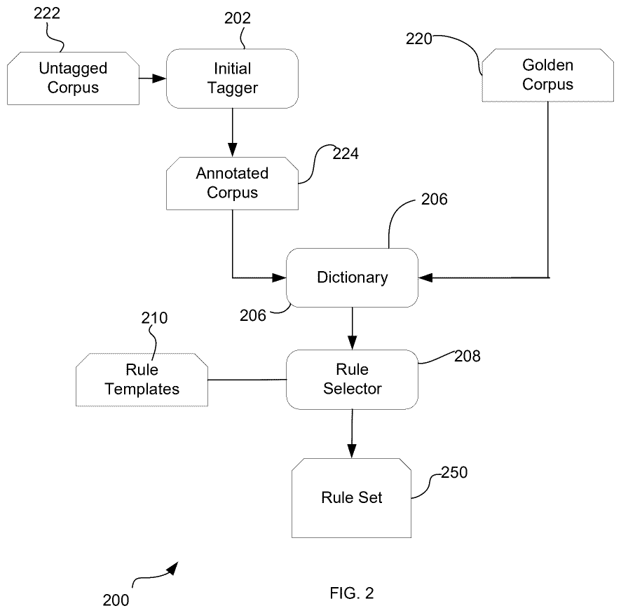

FIG. 2 is a diagrammatic representation of one embodiment of a learning process for an MLRPOS tagging rules learner 200 (learner 200) to learn an MLRPOS tagging rule set 250 that comprises RDR for POS tagging. In the embodiment illustrated, MLRPOS tagging rules learner 200 includes an initial tagger 202, an object dictionary 206, a rules selector 208, and rules template 210.

As will be appreciated, RDR learning exploits a failure-driven approach to restructure transformation rules into a single classification ripple down rules (SCRDR) tree. Thus, in one embodiment, MLRPOS tagging rule set 250 comprises a SCRDR. Nonlimiting examples of SCRDR trees are further described in Debbie Richards, “Two decades of ripple down rules research,” Knowledge Engineering Review, 24 (2): 159-184 (2009), which is hereby fully incorporated by reference.

A SCRDR tree is a finite binary tree with “except” and “if-not” (false) edges. Each node of the tree represents a rule having a condition and a conclusion. The condition of a rule may involve multiple Boolean operations. In the context of POS tagging, the conditions typically involve Boolean operations on one or more of the context of the current token, the lexical properties of the current token, the context of tokens in region R of the current token, the lexical properties of tokens in the region R. The conclusion of each rule is a POS tag. Thus, each node N of the SCRDR tree includes a classification rule for labeling the current token with a POS tag.

For POS tagging, the SCRDR tree is evaluated for the current token. At any node N in the tree, if the condition of a node N's rule is satisfied for the current token, the node N is considered to be fired and the current token is passed to the “except” child of N if an “except” child of N exists. If the condition of node N's rule is not satisfied, the current token is passed to the “if-not” (false) child of N, if an “if-not” child of N exists. The conclusion of a SCRDR tree evaluation is the conclusion (e.g., classification) from the last node in the SCRDR tree which is fired. During learning, new rules are added to the tree when the SCRDR tree evaluation for a token returns a wrong conclusion. Only new rules that are consistent with existing knowledge embodied in the tree are added. For example, a new rule is only added if tokens that were previously classified correctly do not match the new rule.

To train MLRPOS tagging rules learner 200 to learn MLRPOS tagging rule set 250, a raw corpus 222 (e.g., a tokenized raw corpus) is processed using an initial POS tagger 202 to POS tag tokens of the corpus to create an initialized corpus 224. In some embodiments, initial POS tagger 202 uses the same tagging rules as a downstream tagger used in the run-time environment. For example, in one embodiment, MLRPOS tagging rules learner 104 of FIG. 1 uses an initial POS tagger that applies the same tagging rules as initial tagger 124 of search system 120.

For simplicity, the tagged elements are referred to words, though, in some cases, the tagged element may be an n-gram, punctuation or a portion of a word. Here, a “token” is a piece of text that initial POS tagger 202 POS tags. A tagged “token” may represent a portion of a word (e.g., “‘s’”), punctuation, or another element that is POS taggable.

Initialized corpus 224 is compared to baseline corpus 220 to produce an object-driven dictionary of pairs (Object, correctTag) (dictionary 206) where the Object captures the context of a current token, represented as word[0], in initialized corpus 224 and correctTag is the tag assigned to the corresponding token in baseline corpus 220 (i.e., the tag that is considered to be correct for that token). For the sake of example, a sliding window of five tokens is used. According to one embodiment, the object for a “word[0]”, includes the following fields: (word[−2], tag[−2], word[−1], tag[−1], word[0], currentTag, word[1], tag[1], word[2], tag[2]) where:
word[−2]: the token two prior to word[0] in the token sequence;
tag[−2]: the tag assigned to word[−2] in annotated corpus 224;
word[−1]: the token prior to word[0] in the token sequence;
tag[−1]: the tag assigned to word[−1] in annotated corpus 224;
word[0]: the current token;
tag[0]: current tag assigned to word[0] by initial tagger 202 or as updated by a fired rule;
word[1]: the token after word[0] in the token sequence;
tag[1]: the tag assigned to word[1] in initialized corpus 224;
word[2]: the token two after word[0] in the token sequence;
tag[2]: the tag assigned to word[2] in annotated corpus 224.

Rules selector 208 is configured with rule templates 210 that rules selector 208 populates with values from the objects of object dictionary 206. Examples of rule templates include, but are not limited to:
if (tag[0]==“object.tag[0]”) tag==“object.tag[0]”;
if (tag[0]==“object.tag[0]” AND tag[1]==“object.tag[1]”) tag=′correctTag′;
if (word[0]==“object.word[0]”) tag==‘correctTag’;
if (word[0]==“object.word[0]” AND tag[1]=′object.tag[1]”) tag=′correctTag′;
if (word[0]==“object.word[0]” AND word[1]=“object.word[1]”) tag=′correctTag′;
if (tag[1]==“object.tag[1]”) tag=′correctTag′;
if (tag[1]==“object.tag[1]” OR tag[2]==“object.tag[2]”) tag=′correctTag′;
if (word[1]==“object.word[1]”) tag=′correctTag′;
if (word[1]==“object.word[1]” OR word[2]==“object.word[2]”) tag=′correctTag′;
if (tag[−1]==“object.tag[−1]”) tag=′correctTag′;
if (tag[−1]==“object.tag[−1]” AND tag[0]=′object.tag[0]′) tag=′correctTag′;
if (tag[−1]==“object.tag[1]” AND tag[1]=“object.tag[1]”) tag-“correctTag”;
if (tag[−1]==“object.tag[−1]” AND word[0]=′object.word[0]′) tag=′correctTag′;
if (tag[−1]==“object.tag[−1]” AND word[1]=“object.word[1]”) tag=′correctTag′;
if (word[−1]==“object.word[−1]”) tag=′correctTag′;
if (word[−1]==“object.word[−1]” AND word[0]==“object.word[0]”) tag=′correctTag′;
if (word[−1]==“object.word[−1]” AND tag[0]==“object.tag[0]”) tag=′correctTag′;
if (tag[2]==“object.tag[2]”) tag=′correctTag′;
if (word[2]==“object.word[2]”) tag=′correctTag′;
if (tag[−2]==“object.tag[−2]”) tag=′correctTag′;
if (tag[−2]==“object.tag[−2]” OR tag[−1]==“object.tag[−1]”) tag=′correctTag′;
if (word[−2]==“object.word[−2]”) tag=′correctTag′;
if (word[−2]==“object.word[−2]” OR word[−1]==“object.word[−1]”) tag==‘correctTag’;
In these rule templates, tag=′object.tag[0]′ or tag=′correctTag′ represent the conclusions of the rules. During operation, rules selector 208 replaces object.tag[−2], object.tag[−2], object.tag[1], object.tag[2], object.tag[0], object.word[−2], object.word[−2], object.word[1], object.word[2], object.word[0], and correctTag, with the values from the objects in dictionary 206 to create concrete rules, which can be added to a SCRDR tree.

The example rule templates above include a default rule for a tag, “if (tag[0]==” object.tag[0]”) tag==‘object.tag[0]’”.

For example, the default rule for the tag “JJ” is:
if (tag[0]==“JJ”) tag==“JJ”.

The default rule ensures that at least one node fires for each object in the object driven dictionary 206 that has a tag[0].

According to one embodiment, the SCRDR tree begins with a root node that defines a rule. Rules selector 208 only adds new nodes to the tree when the evaluation process returns a wrong conclusion. Rules selector 208 selects which nodes/rules to add based on predefined constraints.

For a node N in the SCRDR tree, let OS1_{(N)} be the set of objects that fire the node N and for which node N provides the correct conclusion (e.g., object.tag[0] after firing node N equals correctTag for the object), OS2_{(N)} be the set of objects that fire node N but for which node N provides the wrong conclusion (e.g., object.tag[0] after firing node N does not equal correctTag for the object). According to one embodiment, rules selector 208 only adds a new rule to the tree only when OS2_{(N)} is not an empty set (i.e., when the evaluation path resulted in an incorrect conclusion).

In order to select a new exception rule to the rule at node-N, rules selector 208 populates the rule templates 210 using the values from objects from OS2_{(N)} to create concrete rules from the objects in the OS2_{(N)} set. To add a rule to the SCRDR tree, rules selector 208 identifies a rule generated from OS2_{(N)} that meets the following constraints:
i) the rule is unsatisfied for objects for which node N has given correct conclusions-that is, the rule is not satisfied by any object in OS1_{(N)};
ii) of the candidate rules generated from OS2_{(N)} and not yet added to the SCRDR tree, the rule has the highest value subtracting B from A, where A is the number of objects in OS2_{(N)} for which the rule results in the correct conclusion and B is the number of objects in OS2_{(N)} for which the rule results in an incorrect conclusion;
iii) the value of B subtracted from A for the rule meets a configurable threshold (in some embodiments, rules selector 208 applies different thresholds for different exception levels).

Rules selector 208 selects the candidate rule with the highest value of A minus B to add as a new rule. If there is no “except” child to node N in the SCRDR tree, rules selector 208 adds the selected rule as an except child to node N. Otherwise, the new rule is added as an “if-not” child to the last node at the first exception level to node N (that is, as an “if-not” descendent from the “except” child to node N). Rules selector 208 may add any number of candidate rules as exceptions to the rule of node N (e.g., in descending A minus B order) until there are no remaining rules that fit the constraints. According to one embodiment, rules selector 208 only adds a candidate rule as a new rule to the tree if none of the objects that were correctly concluded by an existing rule in the tree match the candidate rule.

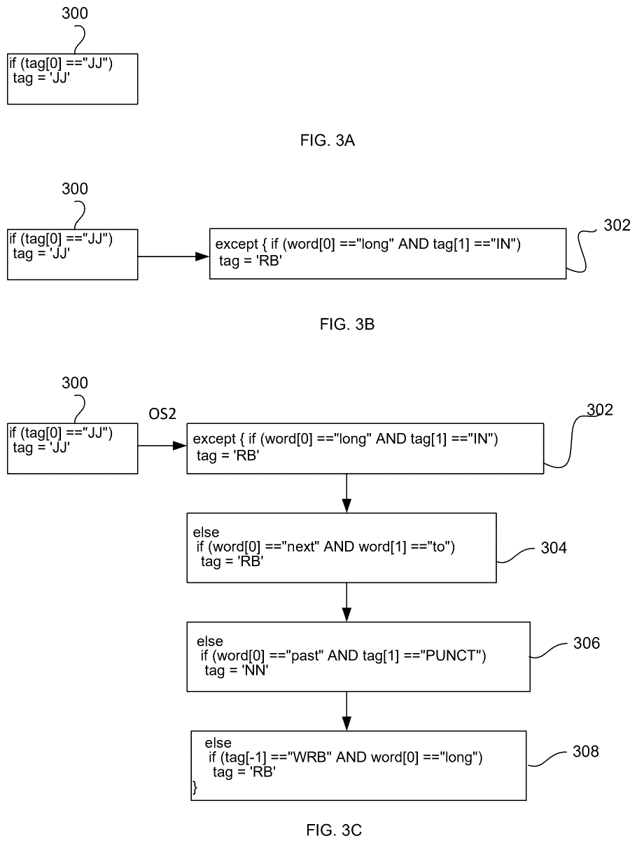

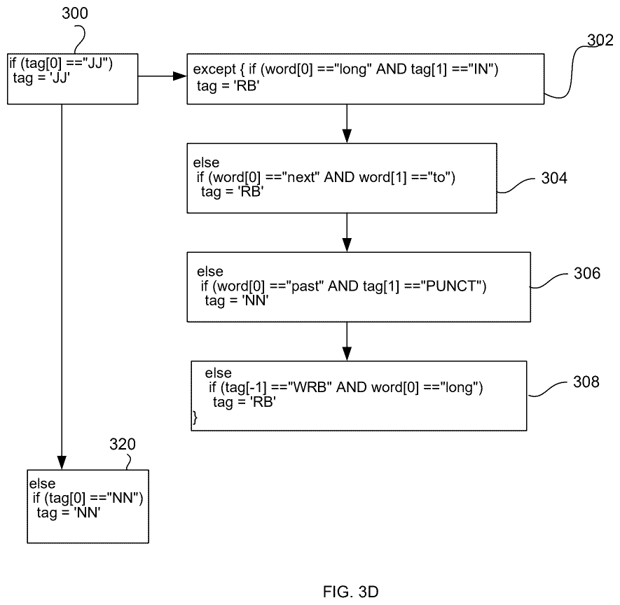

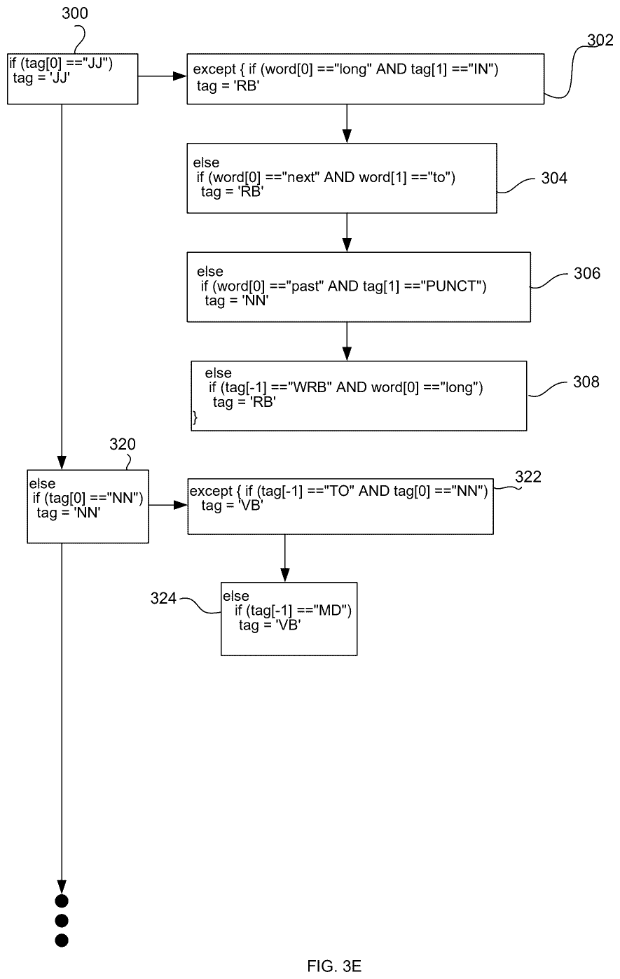

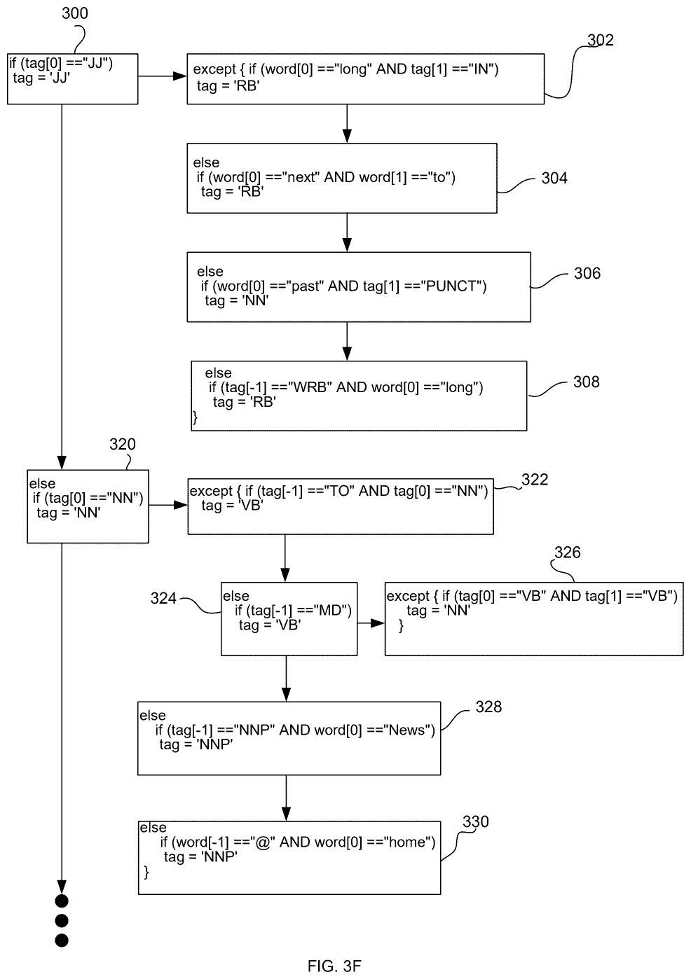

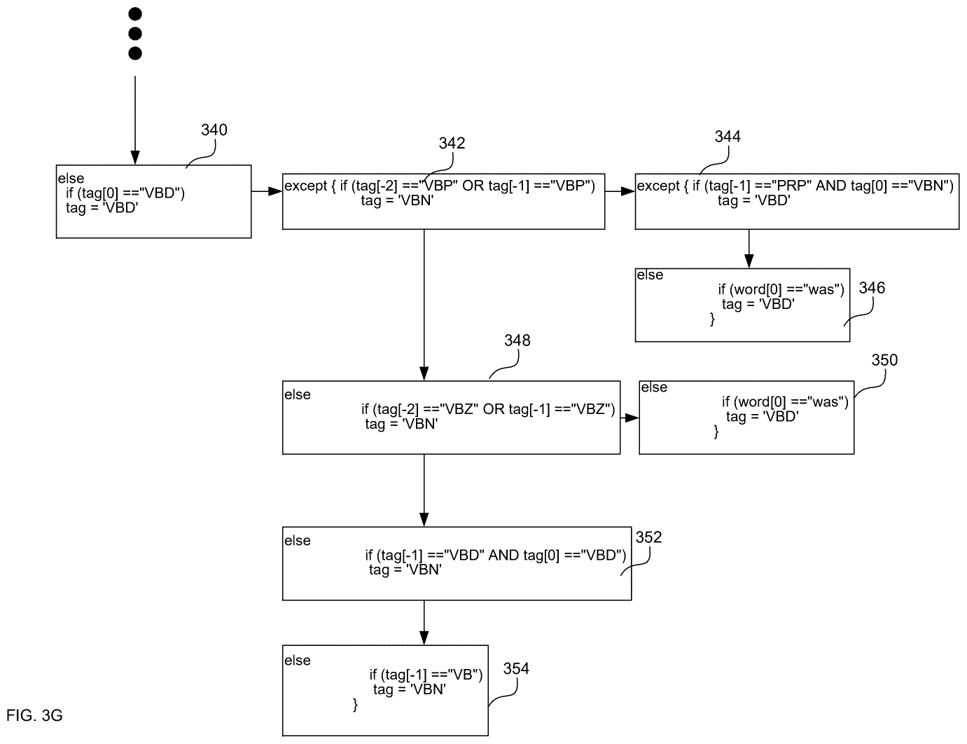

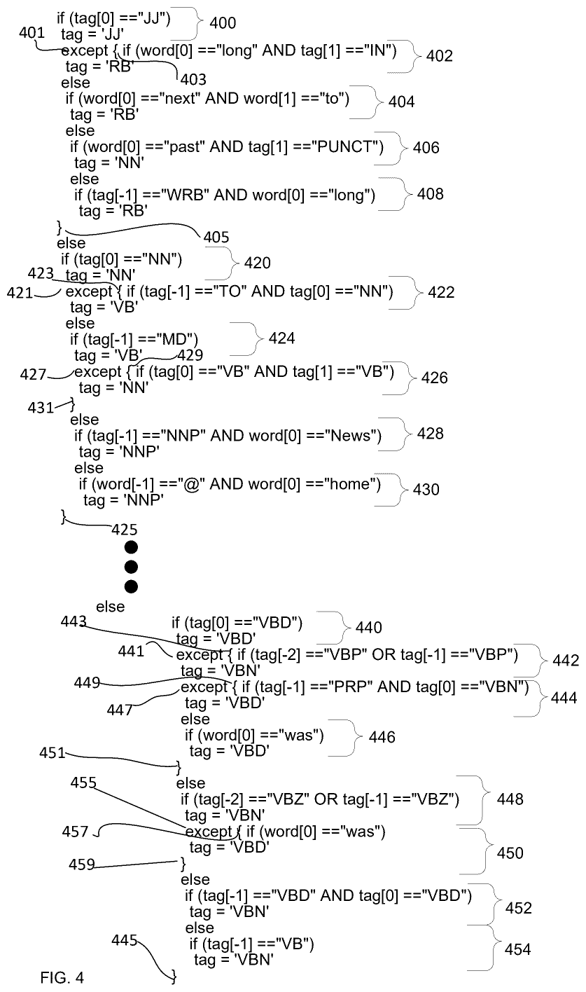

To further describe the learning process, reference is made to FIG. 3A, FIG. 3B, FIG. 3C, FIG. 3D, FIG. 3E, FIG. 3F, FIG. 3G (collectively FIG. 3), which illustrate portions of one embodiment of a SCRDR tree and FIG. 4 which illustrates example rule sets embodying the portions of the SCRDR tree illustrated in FIG. 3.

The SCRDR tree begins with a default rule node for a tag. Default nodes for the other POS tags represented in object driven dictionary 206 or for each tag in a supported POS tag set are added to the SCRDR tree as “if-not” children to the SCRDR tree. In one embodiment, the default rule nodes are ordered in the tree based on the frequency of the corresponding POS tags in object driven dictionary 206, with the default rule node for the most frequent tag being selected as the root node for the SCRDR tree. In another embodiment, the default nodes for the POS tags are added as the tags are first encountered in the sequence of objects from object driven dictionary 206 (e.g., the default rule node for tag[0] from the object that represents the first token in the token sequence of initialized corpus 224 is added as the root node and the default root nodes for the other tags are added as they are encountered as tag[0] in the sequence).

In the example of FIG. 3A the default rule node 300 for the tag “JJ” is added to the SCRDR tree (FIG. 3A). That is, rules selector 208 adds rule 400 as the root rule of the MLRPOS tagging rule set (FIG. 4).

As discussed above, for a node N there are two potential sets of objects from object driven dictionary 206 that fire the node: OS1—the set of objects that fire the node N and for which node N provides the correct conclusion; and OS2—the objects that fire node N but for which node N provides the wrong conclusion. Node 300 will fire for all the objects in object driven dictionary 206 initially assigned a tag[0]==“JJ” and will assign each of these objects tag JJ (that is, tag[0] will remain “JJ”. Thus, for node 300, the two potential sets of objects that fire node 300:
i) OS1₍₃₀₀₎ objects for which tag[0]=“JJ” and correctTag=“JJ”;
ii) OS2₍₃₀₀₎ for which tag[0]=“JJ” and correctTag!=“JJ” (correctTag does not equal “JJ”).

Rules selector 208, according to one embodiment, populates the rule templates 210 using the values from the objects in OS2₍₃₀₀₎ to generate rules and tests the rules using the objects from OS1₍₃₀₀₎ and OS2₍₃₀₀₎.

More particularly, rules selector 208 evaluates the rules to identify a rule that meets the following conditions:
i) the rule is unsatisfied for objects in OS1₍₃₀₀₎;
ii) of the rules generated from OS2₍₃₀₀₎ and not yet added to the SCRDR tree, the rule has the highest value subtracting B from A, where A is the number of objects in OS2₍₃₀₀₎ for which the rule results in the correct conclusion and B is the number of objects in OS2₍₃₀₀₎ for which the rule results in an in an incorrect conclusion;
iii) the value of B subtracted from A for the rule meets a threshold.

In this example, rules selector 208 identifies the following rule as meeting the above conditions:
if (word[0]==“long” AND tag[1]==“IN”) tag=‘RB’

Because there is no exception yet to node 300, rules selector 208 adds node 302 as an “except” child of node 300. Thus, in FIG. 4, rules selector 208 appends an “except” statement 401 to the rules set immediately after rule 400. Rules selector 208 selects rules block of “except” statement 401 as the current rules block and adds rule 402 to the rules block of “except” statement 401 (the rules block of “except statement 401 is bounded by braces 403 and 405 in FIG. 4). The first rule in an “except” statement may be considered the “except” child of the parent node.

On adding a new node/rule to the SCRDR tree, rules selector 208 evaluates whether an exception should be added for that rule. For example, rules selector 208 evaluates whether to add an exception to the rule of node 302 (that is, an exception to rule 402). Of the objects from OS2₍₃₀₀₎ that fire node 302, node 302 updates the objects with tag=‘RB’, thereby updating tag[0] of these objects to ‘RB’, thus there are two potential sets of objects that fired node 302:
ii) OS1₍₃₀₂₎—objects that fire the node 302 and for which node 302 provides the correct conclusion (objects for which, tag[0]=“RB”, word[0]=“long”, tag[1]=“IN”, and correctTag=“RB”); and
ii) OS2₍₃₀₂₎—objects that fire node 302 but for which node 302 provides the wrong conclusion (objects for which tag[0]=“RB”, word[0]=“long”, tag[1]=“IN”, and correctTag!=“RB”).

Rules selector 208 populates the rule templates 210 using the values from the objects in OS2₍₃₀₂₎ to generate candidate rules and tests the rules using the objects from OS1₍₃₀₂₎ and OS2₍₃₀₂₎. Rules selector 208 evaluates the rules generated from OS2₍₃₀₂₎ according to the constraints discussed above. More particularly, rules selector 208 identifies a rule that i) is not satisfied by any of the objects in OS1₍₃₀₂₎; ii) has the highest value (compared to other candidate rules) from subtracting B from A, where A is the number of objects in OS2₍₃₀₂₎ for which the rule results in the correct conclusion and B is the number of objects in OS2₍₃₀₂₎ for which the rule results in an incorrect conclusion; and iii) for which the value of A minus B is above a threshold. Here, rules selector 208 does not add an exception rule to the rule of node 302 either because OS2₍₃₀₂₎ was an empty set or none of the rules generated from OS2₍₃₀₂₎ met the threshold.

For a given node N, however, there may be multiple rules that meet the constraints for adding a new rule. For example, rules selector 208 may also identify each of the following rules generated from OS2₍₃₀₀₎ as meeting the constraints to be exceptions to the rule of node 300.
if (word[0]==“next” AND word[1]==“to”) tag=‘RB’
if (word[0]==“past” AND tag[1]==“PUNCT”) tag=‘NN’
if (tag[−1]==“WRB” AND word[0]==“long”) tag=‘RB’

In one embodiment, rules selector 208 adds these rules as “if-not” children to the first exception level of node 300 in descending A minus B order (checking for exceptions at each new node) until there are no remaining rules that meet the constraints. In some embodiments, rules selector 208 only adds a rule if none of the objects that were correctly concluded by an existing rule in the tree match the rule.

Thus, in FIG. 3C, rules selector 208 identifies the rule “if (word[0]==“next” AND word[1]==“to”) tag=‘RB’” as not satisfied OS1₍₃₀₀₎, not satisfied by OS1₍₃₀₂₎, and having the highest value of A minus B of the rules generated from OS2₍₃₀₀₎ that have not yet been added to the SCRDR tree, and having a value of A minus B that meets a defined threshold. As such, rules selector 208 adds node 304 as an “if-not” child of node 302 (e.g., rules selector 208 appends rule 404 as an “else if” rule within the current rules block—that is, the rules block of “except” statement 401). Rules selector 208 can repeat this process to add additional nodes 306, 308 to the first exception level (e.g., add rules 406, 408 as “else if” statements in the rules block of “except” statement 401) until there are no more candidate rules generated from OS2₍₃₀₀₎ that meet the constraints. When there are no further rules that qualify to be exceptions to the rule of node 300, rules selector 208 closes the rules block of except statement 401 and returns to the default rules level as the current rules block.

Turning to FIG. 3D, rules selector 208 adds a default rule node 320 as an “if-not” child of at the default rule node level. Thus, rules selector 208 appends rule 420 as an “else if” statement at the default rule level. Default node 320 will fire for all the objects in object driven dictionary 206 initially assigned a tag[0]==“NN”. Of the objects that fire node 320, there are two potential object sets: OS1₍₃₂₀₎—objects that fire the node 320 and for which node 320 provides the correct conclusion (e.g., correctTag=“NN” for the object), and OS2 (320)-objects that fire node 320 but for which node 320 provides the wrong conclusion (e.g., objects for which correctTag does not equal “NN”).

Rules selector 208, according to one embodiment, populates the rule templates 210 using the values from the objects in OS2 (320) to generate candidate rules and tests the candidate rules using the objects from OS2 (320) and OS1₍₃₂₀₎ according to the constraints discussed above. In this example, rules selector 208 identifies the rule of node 322 as the highest value exception rule that meets the constraints and adds node 322 to the SCRDR tree to create a first exception level to default node 320 (FIG. 3E). As illustrated in FIG. 4, rules selector 208 appends a first “except” statement 421 that defines a first exception level for rule 420, selects the rules block of “except” statement 421 as the current rules block, and adds rule 422 to the rules block of “except” statement 421, where the rules block of “except” statement 421 is bounded by braces 423 and 425.

As discussed above, rules selector 208 can further evaluate whether there is an exception to the newly added rule—in this case, an exception to the rule of node 322. Here, rules selector 208 does not identify an exception rule to the rule of node 322.

Additionally, rules selector 208 may continue evaluating rules generated from OS2 (320) to identify additional exceptions to node 320. Continuing with the example of FIG. 3E, rules selector 208 identifies the rule “if (tag[−1]==“MD”) tag=‘VB’” as qualifying to be an exception to the rule of node 320 and, since there is already an “except” child of node 320, appends node 324 as an “if-not” child of node 322. Thus, in FIG. 4, rules selector 208 appends rule 424 as an “else if” rule in the current rules block (the rules block of “except” statement 421).

Rules selector 208 can further evaluate if there is an exception to the rule of node 324. Rules selector 208, according to one embodiment, populates the rule templates 210 using the values from the objects in OS2 (324) to generate candidate rules and tests the candidate rules using the objects from OS2 (324) and OS1 (324). Because the objects in OS2 (324) and OS1 (324) fired node 324, the object.tag[0] in each of these objects is set to “VB”.

In the example of FIG. 3F, rules selector 208 determines that the rule: if (tag[0]==“VB” AND tag[1]==“VB”) tag=‘NN’ is the highest value rule that meets the constraints to be an exception to the rule of node 324 and adds node 326 as an “except” child of node 324, creating a first exception level to node 324 and a second exception level to node 320. Thus, as illustrated in FIG. 4, rules selector 208 appends a second “except” statement 427 in the rules block of first “except” statement 421 and selects the rules block of “except” statement 427 as the current rules block. Here, the second “except” statement designates a second exception level rules block bounded by braces 429, 431, which is nested in the earlier “except” statement's rules block. Rules selector 208 further adds rule 426 to the current rules block (the rules block of “except” statement 427).

Rules selector 208 does not identify any exceptions to rule 426 or additional exceptions to rule 424 and thus closes “except” statement 427 with brace 431, returning to the next outer rules block as the current rules block (that is, returns to the rules block of “except” statement 421 as the current rules block. Rules selector 208 identifies several additional rules generated from OS2₍₃₂₀₎ to add as exception rules to the rule of node 320. In the example of FIG. 3F, rules selector 208 adds node 328 and node 330 as “if-not” children to the first exception level of node 320 (e.g., appends rule 428 and rule 430 as “else if” rules in the current rules block). When there are no more rules that qualify as exceptions to rule 420, rules selector 208 closes “except” statement 421 with brace 425, returning to the next outer rules block as the current rules block—in this case, returning to the default rules level.

Turning to the example of FIG. 3G, rules selector 208 adds a default rule node 340 as an “if-not” child at the default rule node level. For example, rules selector 208 appends the default rule for tag “VDB” (rule 440) to the rules set as an “else if” rule. In this example, rules selector 208 identifies the rule of node 342 as the highest value exception rule to the rule of node 340 and adds node 342 to the SCRDR tree as an “except” child of node 340 to create a first exception level to default node 340. As illustrated in FIG. 4, rules selector 208 opens a first “except” statement 441 that defines a first exception level for rule 440, selects the rules block of the first “except” statement as the current rules block and adds rule 442 to the “except” statement. The rules block of “except” statement 441 is bounded by braces 443, 445 in FIG. 4.

Rules selector 208 can further evaluate whether exception rules to the rule of node 342 are to be added. In the example of FIG. 3G, rules selector 208 determines that the rule “if (tag[−1]==“PRP” AND tag[0]==“VBN”) tag=‘VBD’ is the highest value rule that meets the constraints above and adds node 344 as an “except” child of node 342, creating a first exception level to node 342 and a second exception level to node 340. Thus, as illustrated in FIG. 4, rules selector 208 appends a “except” statement 447 in rules the block of the earlier “except” statement 441, selects the rules block of “except” statement 447 as the current rules block, and adds rule 444 to the rules block of the second “except” statement 447. Here, the second “except” statement designates a second rules block of the second exception level to rule 440, bounded by braces 449, 451.

In this example, rules selector 208 does not identify any exceptions to the rule of node 344. However, rules selector 208 identifies the rule “if (word[0]==“was”) tag=‘VBD’” as an exception rule to the rule of node 342 (rule 442). Rules selector 208 adds node 346 as an “if-not” child of node 344. Accordingly, in FIG. 4, rules selector 208 appends rule 446 as an “else if” to the current rules block—that is, rules selector 208 appends rule 446 to the rules block of “except” statement 447. As there are no more rules that qualify to be added to the current rules block, rules selector 208 returns to the next outer rules block as the current rules block (e.g., rules selector 208 returns to the rules block of “except” statement 441 as the current rules block.

Rules selector 208 further evaluates the rules generated from OS2 (340) to determine if any other candidate rules qualify as exceptions to the rule of node 340. In this example, rules selector 208 identifies an additional rule that meets the constraints and adds node 348. Thus, in FIG. 4, rules selector 208 appends rule 448 as an “else if” rule in the rules block of “except” statement 441.

Further, rules selector 208 identifies a qualifying exception to the rule of node 348 and adds node 350 as an “except” child of node 348. Here, rules selector 208 appends “except” statement 455 to the rules block of “except” statement 441, selects the rules block of “except” statement 455 as the current rules block, and adds rule 450 to the current rules block (i.e., the rules block of “except” statement 455). The rules block of “except” statement 455 is bounded by braces 457, 459 in FIG. 4.

Rules selector 208, in this example, does not identify any exceptions to the rule of node 350 or additional exceptions to the rule of node 348. Rules selector 208 therefore closes the rules block of “except” statement 455 and selects the next outer rules block as the current rules block. Thus, rules selector 208 selects the rules block of “except” statement 441 as the current rules block.

Rules selector 208 identifies additional rules that qualify as exceptions to the rule of node 340 and adds node 352 and node 354 as “if not” children to the first exception level to node 340. Thus, in FIG. 4, rules selector 208 adds rule 452 and rule 454 as a string of “else if” rules to the rules block of “except” statement 441. When there are no more rules that qualify as exceptions to the rule of node 340, rules selector 208 can close the rules block of “except” statement 441 and move to the next outer rules block as the current rules block. Here, rules selector 208 can select the default rules level as the current rules block.

Embodiments of a code generator may translate a SCRDR tree into MLRPOS tagger code that embodies the SCRDR tree. In generating the MLRPOS tagger code, the code generator may apply various optimizations. For the sake of example, the translation of RDR to code is discussed using an example embodiment in which the code generator is a Java compiler that translates the RDR into computer code, such as Java code. It will be appreciated, however, that RDR may be translated into other languages in other embodiments.

According to one embodiment, the code generator (e.g., code generator 106) performs a first pass compilation to replace tag string comparisons with an enumeration. In a second pass, the code generator reduces a sequence of nested if/“else” statements on the same conditions down to a switch statement.

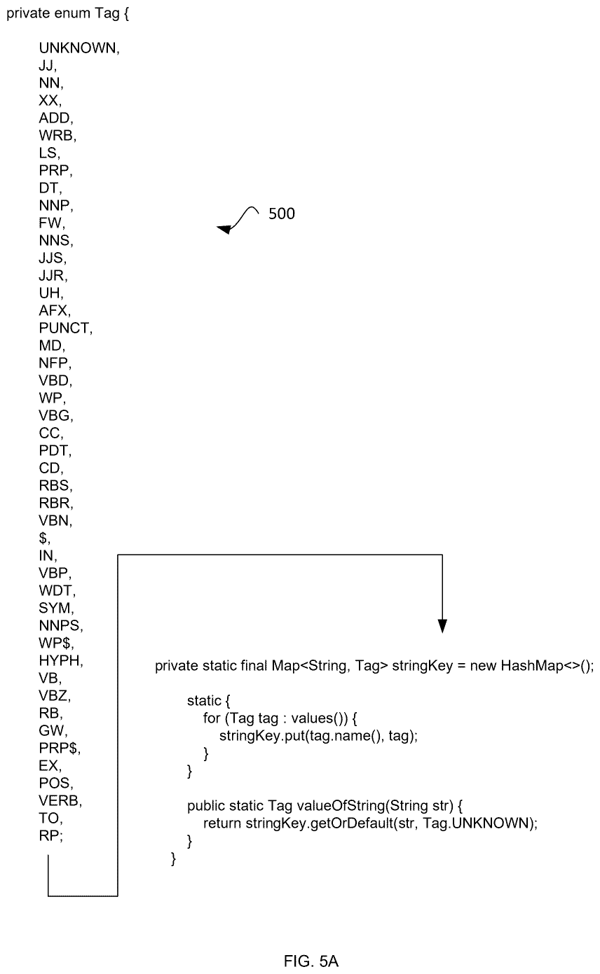

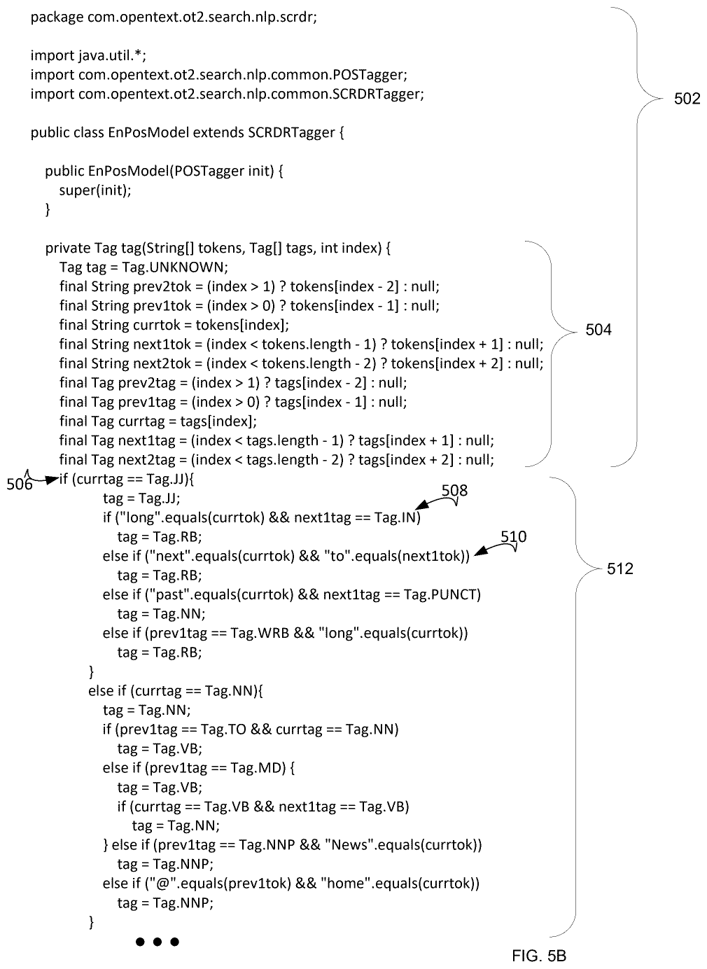

FIG. 5A includes an example of a Java enumeration (enum type) named “Tag”. Here, the code generator parses the RDR to extract the distinct POS tags and uses the POS tags as the predefined constants (constants 500) of the enum type. The remainder of enum type may be pre-defined, such as by a code template (e.g., template 114) or otherwise provided.

FIG. 5B illustrates an example of another portion of tagger code. Here, section 502 of the tagger code is predefined, such as by a template (e.g., template 114). The tagger code includes code to determine the appropriate tag for a specific token. In FIG. 5B, “tokens” is an array of strings, each representing a token, “tags” is an array of “tag” objects, each representing a tag associated with a token, “index” is an integer indicating the position of the current token in the “tokens” array for which the tag is to be determined.

Section 504 initializes variables for a sliding window approach like that used during the learning process. During the first pass compilation the code generator maps the object attributes used in the RDR to these variables replacing tag strings with the enumeration. In this example, the tagger maps the object attributes to the variables as illustrated in Table 1, which is provided by way of example and not limitation:

TABLE 1

| object attribute | variable | variable description |
|---|---|---|
| word[0] | currtok | the current token to be tagged. |
| word[−2] | prev2tok | the token two positions before the |
| | | current token in the “tokens” array, |
| | | or “null” if not applicable: |
| word[−2] | prev1tok | the token one position before the |
| | | current token in the “tokens” array, |
| | | or “null” if not applicable |
| word[1] | next1tok | the token one position after the |
| | | current token in the “tokens” array, |
| | | or “null” if not applicable |
| word[2] | next2tok | the token two positions after the |
| | | current token in the “tokens” array, |
| | | or “null” if not applicable |
| tag[0] | currtag: | the current tag; |
| tag[−2] | prev2tag: | the tag two places before currtag |
| | | in the “tags” array (the tag |
| | | associated with prev2tok), or “null” |
| | | if not applicable; |
| tag[−1] | prev1tag | the tag one place before currtag in |
| | | the “tags” array (the tag |
| | | associated with prev1tok) or “null” |
| | | if not applicable; |
| tag[1] | next1tag | the tag one place after currtag in |
| | | the “tags” array (the tag |
| | | associated with next1tok) or “null” |
| | | if not applicable. |
| tag[2] | next2tag | the tag two place after currtag in |
| | | the “tags” array (the tag |
| | | associated with next2tok) or “null” |
| | | if not applicable. |

According to one embodiment, a first pass compilation translates the RDR directly to Java statements. In the illustrated embodiment of FIG. 5B, the rules generator translates the rule from the first node of the SCRDR tree is translated into a Java “if”statement and appends the statement to the tagger code. In this example, rule 400 of FIG. 4 is translated into Java and added as “if” statement 506. Initially, “if” statement 506 is a single statement “if” statement.

The code generator parses the rules in order, adding translated rules to the tagger code. For each additional rule R, the code generator determines if the rule is an “except” child or an “if-not”child. If the rule is an “except” rule, the code generator appends the translated rule to the code block of the immediately prior “if” or “else if” statement. For example, when the code generator detects a “except { . . . }” the code generator adds the translated rules contained in the rules block of the “except” statement to the code block of the “if” or “else if” statement.

With reference to FIG. 4, when the code generator encounters except statement 401. The except statement is translated into a Java “if” statement 508, which is appended to the code block of if statement 506. If the rule R is an “if not” child, the code generator appends an else-if statement to the current code block. For example, the rules generator adds else-if statement 510 for rule 404 to the code block of statement 506. The code generator closes the current code block when it encounters the end brace of an “except” child. For example, the code generator closes the code block of “if” statement 506 when it reaches brace 405 (the closing brace of except statement 401). The code generator continues parsing the rules and translating the rules into Java “if” or “else if” statements nesting the Java statements according to the structure defined by the rules.

A second pass of compilation optimizes a nested set of [if tags [index]== . . . )] expressions on the same key to a switch statement. FIG. 5C, for example, illustrates Java code in which the nested Java statements of code portion 512 of FIG. 5B are optimized on the currtag key.

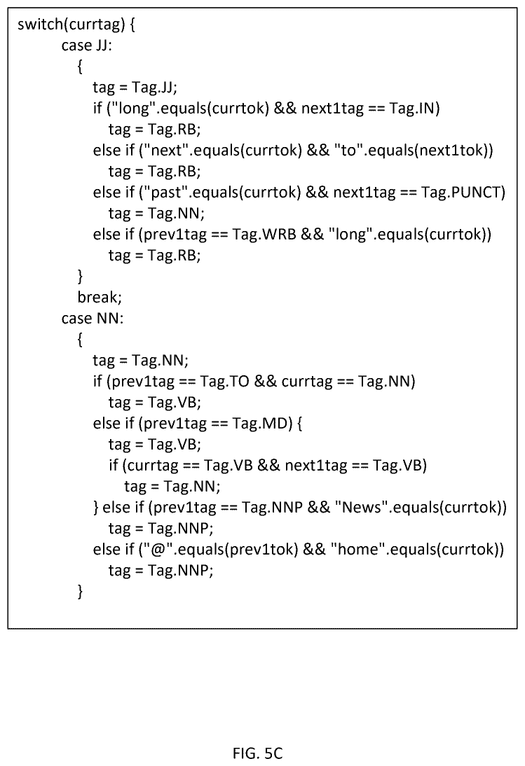

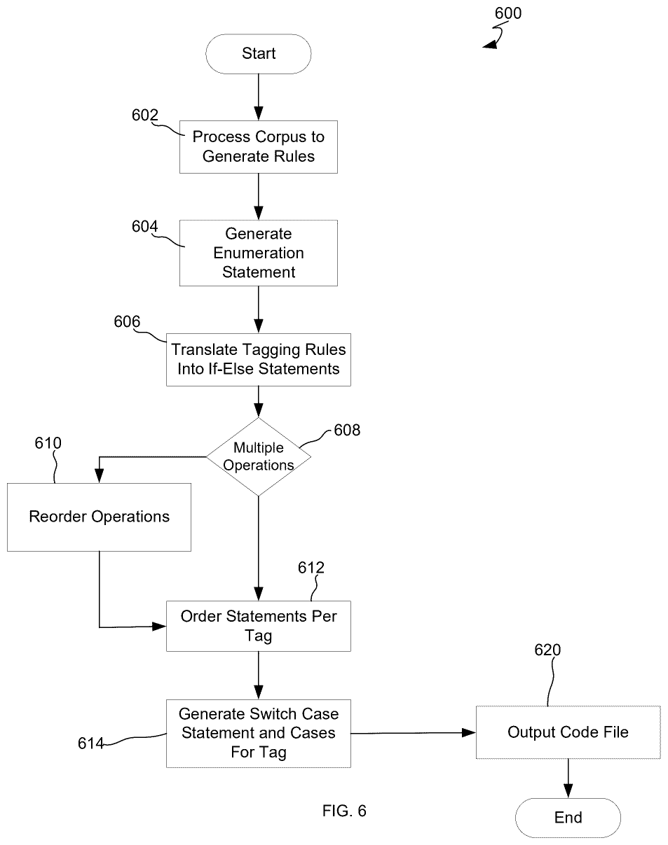

FIG. 6 is a flowchart illustrating one embodiment of a method 600 for generating MLRPOS tagger code. The method 600 may be implemented using software, hardware or a combination of software and hardware. In some embodiments, method 600 is embodied as computer-executable instructions stored on a non-transitory, computer-readable medium.

At step 602, a corpus of documents is processed using a machine learning rules generator to generate RDR for POS tagging for a language. According to one embodiment, the RDR comprises rule sets for tags in a tag set. The rule set for a tag in the tag set may include a default rule for the tag and exception rules for the tag. The rules can include tag string comparisons.

At step 604, a code generator generates an enumeration statement for an enumeration containing the tag set. At step 606, the code generator translates the RDR rules into code statements. For example, the code generator translates the rules for the tag into if-else statements for the tags. Translating the rules includes replacing the tag string comparisons with the enumeration.

At step 608, the rules generator parses the generated if-else statements to determine if each if-else statement includes a Boolean expression with multiple Boolean operations. If an if-else statement includes a Boolean expression with multiple Boolean operations, the code generator may reorder the Boolean operations to put a less expensive operation before a more expensive operation in the Boolean expression (step 610).

Other optimizations may also be applied. For example, the RDR may comprise a plurality of rules comprising token strings as conditions. Compiling the RDR into the code may comprise reordering the if-else statements per tag based on a relative frequency of execution (step 612).

At step 614, the code generator generates a switch case statement for a current tag. The switch case statement may have a plurality of cases. For example, the switch case statement may have a case for each tag in the tag set. The switch case statement for a tag includes the if-else statements for the respective tag.

At step 620, the code generator outputs the optimized code, which comprises the enumeration statement and the switch case statement. The optimized code may also include, for example, template code.

FIG. 6 is merely an illustrative example, and the disclosed subject matter is not limited to the ordering or number of steps illustrated. Embodiments may implement additional steps or alternative steps, omit steps, or repeat steps.

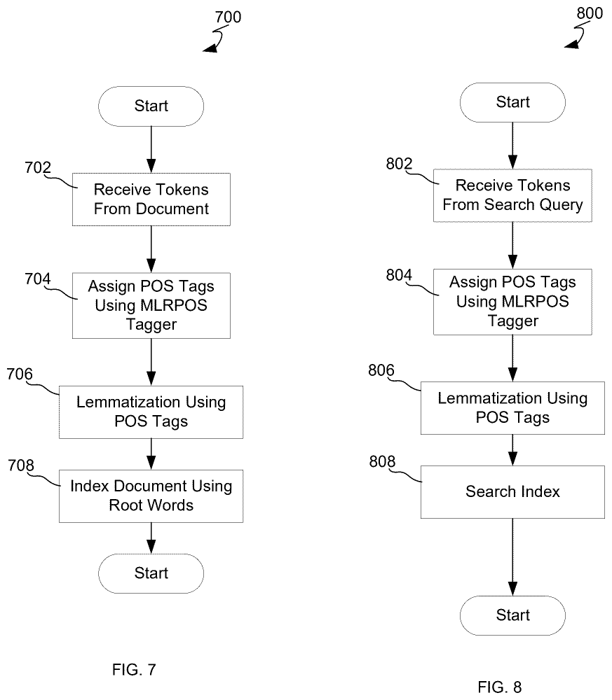

FIG. 7 is a flowchart illustrating one embodiment of a method 700 using an MLRPOS tagger in document indexing. The method 700 may be implemented using software, hardware or a combination of software and hardware. In some embodiments, method 700 is embodied as computer-executable instructions stored on a non-transitory, computer-readable medium.

At step 702, tokens generated from a document to be indexed are received. At step 704, the MLRPOS tagger is executed to assign part-of-speech tags to the tokens. At step 706, lemmatization of the tokens is performed using the part-of-speech tags to determine root words for the tokens and, at step 708, the document is indexed. Indexing the document can include adding the root words determined for the tokens to an index.

FIG. 7 is merely an illustrative example, and the disclosed subject matter is not limited to the ordering or number of steps illustrated. Embodiments may implement additional steps or alternative steps, omit steps, or repeat steps.

FIG. 8 is a flowchart illustrating one embodiment of a method 800 using an MLRPOS tagger in document searching. The method 800 may be implemented using software, hardware or a combination of software and hardware. In some embodiments, method 800 is embodied as computer-executable instructions stored on a non-transitory, computer-readable medium.

At step 802, tokens generated from a search query are received. At step 804, the MLRPOS tagger is executed to assign part-of-speech tags to the tokens. At step 806, a lemmatization of the tokens is performed using the part-of-speech tags to determine root words for the tokens. At step 808, an index is searched using the root words determined for the plurality of tokens.

FIG. 8 is merely an illustrative example, and the disclosed subject matter is not limited to the ordering or number of steps illustrated. Embodiments may implement additional steps or alternative steps, omit steps, or repeat steps.

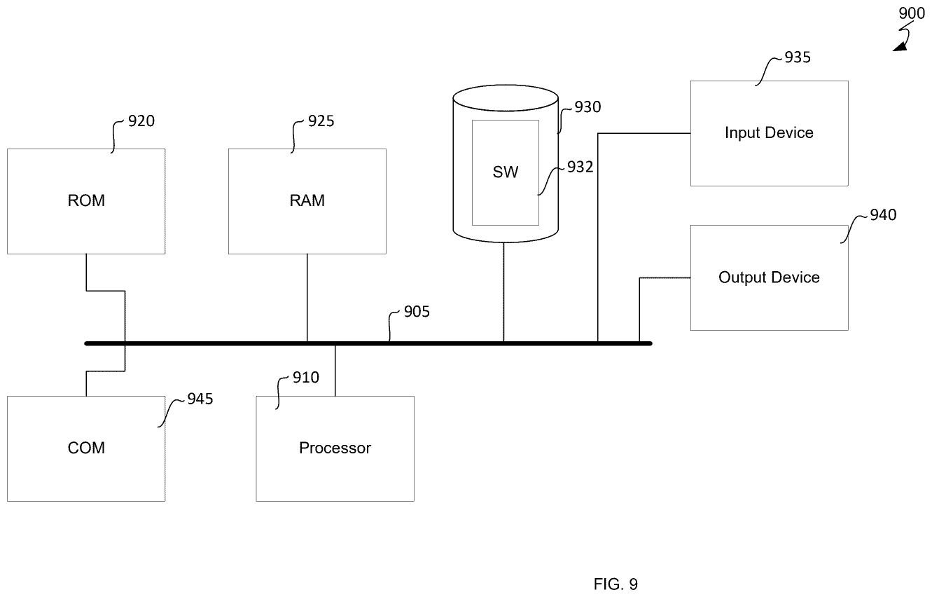

FIG. 9 illustrates an embodiment of a computing system 900. Embodiments of one or more of components computing system 900 are in electrical communication with each other using a bus 905. Exemplary computing system 900 includes a processing unit (CPU or processor) 910 and a system bus 905 that couples various system components including the system memory, such as read only memory (ROM) 920 and random-access memory (RAM) 925, to the processor 910. The system memory can include multiple different types of memory with different performance characteristics. Processor 910 may contain multiple cores or processors, a bus, memory controller, cache, etc. Software 932 stored in storage device 930, may be configured to control processor 910. The software may be executable such that computing system architecture provides one or more of MLRPOS tagger generator 100, tokenizer 103, learner 104, code generator 106, client 140, client 140, search system 120, tokenizer 122, initial tagger 124, MLRPOS tagger 126, term selector 128, or search engine 130.

To enable user interaction with computing system 900, an input device 935 can represent any number of input mechanisms, such as a microphone for speech, a touch-sensitive screen for gesture or graphical input, keyboard, mouse, motion input, speech and so forth. An output device 940 can also be one or more of a number of output mechanisms known to those of skill in the art. The communications interface 945 can generally govern and manage the user input and system output. There is no restriction on operating on any particular hardware arrangement and therefore the basic features here may easily be substituted for improved hardware or firmware arrangements as they are developed.

Storage device 930 is a non-volatile memory and can be a hard drive (e.g., a solid-state drive or other type of hard drive) or other types of computer readable media which can store data that is accessible by a computer. Storage device 930 can include software 932 for controlling the processor 910. A hardware module that performs a particular function can include the software component stored in a computer-readable medium in connection with the necessary hardware components to carry out the function.

Portions of the methods described herein may be implemented in suitable software code that may reside within RAM, ROM, a hard drive or other non-transitory storage medium. Alternatively, the instructions may be stored as software code elements on a data storage array, magnetic tape, floppy diskette, optical storage device, or other appropriate data processing system readable medium or storage device.

Although the invention has been described with respect to specific embodiments thereof, these embodiments are merely illustrative, and not restrictive of the invention as a whole. Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Those skilled in the relevant art will appreciate that the invention can be implemented or practiced with other computer system configurations including, without limitation, multi-processor systems, network devices, mini-computers, mainframe computers, data processors, and the like. The invention can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. At least portions of the functionalities or processes described herein can be implemented in suitable computer-executable instructions. The computer-executable instructions may reside on a computer readable medium, hardware circuitry or the like, or any combination thereof.

Any suitable programming language can be used to implement the routines, methods or programs of embodiments of the invention described herein. Different programming techniques can be employed such as procedural or object oriented. Other software/hardware/network architectures may be used. Communications between computers implementing embodiments can be accomplished using any electronic, optical, radio frequency signals, or other suitable methods and tools of communication in compliance with known network protocols.

Particular routines can be executed on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps and operations described herein can be performed in hardware, software, firmware or any combination thereof.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Generally then, although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

What is claimed is:

1. A computer-implemented method for a machine learning based rules compiler, the method comprising:
processing a corpus of documents using a machine learning rules generator to generate ripple down rules for part-of-speech tagging for a language, the ripple down rules comprising exception rules for tags in a tag set, the exception rules comprising tag string comparisons;
compiling the ripple down rules into optimized computer code, further comprising:
generating an enumeration statement for an enumeration containing the tag set;
translating the exception rules for each tag in the tag set into if-else statements for the tag, translating the exception rules further comprising replacing the tag string comparisons with the enumeration; and
generating a switch case statement for a current tag, the switch case statement having a plurality of cases, each case in the plurality of cases corresponding to a respective tag from the tag set and including the if-else statements for the respective tag, wherein the optimized computer code comprises the enumeration statement and the switch case statement.

2. The method of claim 1, wherein compiling the ripple down rules into the optimized computer code further comprises:
determining that an if-else statement comprises a Boolean expression containing a plurality of operations; and
reordering the plurality of operations to put a less expensive operation before a more expensive operation in the Boolean expression.

3. The method of claim 1, wherein the ripple down rules comprise a plurality of rules comprising token strings as conditions, and wherein compiling the ripple down rules into the optimized computer comprises translating the plurality of rules into corresponding if-else statements ordered based on a relative frequency of execution.

4. The method of claim 1, wherein the machine learning rules generator is trained on tagged training data and applies a failure-driven approach, and wherein the machine learning rules generator outputs single classification ripple down rules.

5. The method of claim 1, further comprising indexing a document for search, wherein indexing the document comprises:
receiving a plurality of tokens generated from the document;
executing the optimized computer code to assign part-of-speech tags to the plurality of tokens;
performing a lemmatization of the plurality of tokens using the part-of-speech tags to determine root words for the plurality of tokens; and
indexing the document using the root words.

6. The method of claim 1, further comprising processing a search query, wherein processing the search query comprises:
receiving a plurality of tokens generated from the search query;
executing the optimized computer code to assign part-of-speech tags to the plurality of tokens;
performing a lemmatization of the plurality of tokens using the part-of-speech tags to determine root words for the plurality of tokens; and
searching an index using the root words.

7. A computer system comprising:
a processor;
a computer memory;
a machine learning ripple down rules generator executable to process a corpus of documents to generate ripple down rules for part-of-speech tagging, the ripple down rules comprising exceptions rules for tags in a tag set, the exception rules comprising tag string comparisons;
a code compiler executable to compile the ripple down rules into optimized computer code, wherein compiling the ripple down rules into optimized computer code comprises:
generating an enumeration statement for an enumeration containing the tag set;
translating the exception rules for each tag in the tag set into if-else statements, translating the exception rules further comprising replacing the tag string comparisons with the enumeration; and
generating a switch case statement for a current tag, the switch case statement having a plurality of cases, each case in the plurality of cases corresponding to a respective tag from the tag set and including the if-else statements for the respective tag, wherein the optimized computer code comprises the enumeration statement and the switch case statement.

8. The computer system of claim 7, wherein compiling the ripple down rules into the optimized computer code further comprises:
determining that an if-else statement comprises a Boolean expression containing a plurality of operations; and
reordering the plurality of operations to put a less expensive operation before a more expensive operation in the Boolean expression.

9. The computer system of claim 7, wherein the ripple down rules comprise a plurality of rules comprising token strings as conditions, and wherein compiling the ripple down rules into the optimized computer code comprises translating the plurality of rules into corresponding if-else statements ordered based on a relative frequency of execution.

10. The computer system of claim 7, wherein the machine learning ripple down rules generator is trained on tagged training data and applies a failure-driven approach, and wherein the machine learning ripple down rules generator outputs single classification ripple down rules.

11. The computer system of claim 7, further comprising code executable to:
receive a first plurality of tokens generated from a document to be indexed;
execute the optimized computer code to assign first part-of-speech tags to the first plurality of tokens;
perform a lemmatization of the first plurality of tokens using the first part-of-speech tags to determine root words for the first plurality of tokens; and
index the document, indexing the document comprising adding the root words determined for the first plurality of tokens to an index.

12. The computer system of claim 11, further comprising code executable to:
receive a second plurality of tokens, the second plurality of tokens generated from a search query;
execute the optimized computer code to assign second part-of-speech tags to the second plurality of tokens;
perform a lemmatization of the second plurality of tokens using the second part-of-speech tags to determine root words for the second plurality of tokens; and
search the index using the root words determined for the second plurality of tokens.

13. The computer system of claim 7, further comprising code executable to:
receive a plurality of tokens generated from a search query;
execute the optimized computer code to assign part-of-speech tags to the plurality of tokens;
perform a lemmatization of the plurality of tokens using the part-of-speech tags to determine root words for the plurality of tokens; and
search an index using the root words.

14. A computer program product comprising a non-transitory, computer-readable medium storing thereon computer-executable instructions, the computer-executable instructions comprising instructions for:
processing a corpus of documents using a machine learning rules generator to generate ripple down rules for part-of-speech tagging for a language, the ripple down rules comprising exception rules for tags in a tag set, the exception rules comprising tag string comparisons;
compiling the ripple down rules into optimized computer code, further comprising:
generating an enumeration statement for an enumeration containing the tag set;
translating the exception rules for each tag in the tag set into if-else statements for the tag, translating the exception rules further comprising replacing the tag string comparisons with the enumeration; and
generating a switch case statement for a current tag, the switch case statement having a plurality of cases, each case in the plurality of cases corresponding to a respective tag from the tag set and including the if-else statements for the respective tag, wherein the optimized computer code comprises the enumeration statement and the switch case statement.

15. The computer program product of claim 14, wherein compiling the ripple down rules into the optimized computer code further comprises:
determining that an if-else statement comprises a Boolean expression containing a plurality of operations; and
reordering the plurality of operation to put a less expensive operation before a more expensive operation in the Boolean expression.

16. The computer program product of claim 14, wherein the ripple down rules comprise a plurality of rules comprising token strings as conditions, and wherein compiling the ripple down rules into the optimized computer code comprises translating the plurality of rules into corresponding if-else statements ordered based on a relative frequency of execution.

17. The computer program product of claim 14, wherein the machine learning rules generator is trained on tagged training data and applies a failure-driven approach, and wherein the machine learning rules generator outputs single classification ripple down rules.

18. The computer program product of claim 14, wherein the computer-executable instructions further comprise instructions executable for:
receiving a first plurality of tokens generated from a document to be indexed;
executing the optimized computer code to assign first part-of-speech tags to the first plurality of tokens;
performing a lemmatization of the first plurality of tokens using the first part-of-speech tags to determine root words for the first plurality of tokens; and
indexing the document, indexing the document comprising adding the root words determined for the first plurality of tokens to an index.

19. The computer program product of claim 18, wherein the computer-executable instructions further comprise instructions executable for:
receiving a second plurality of tokens, the second plurality of tokens generated from a search query;
executing the optimized computer code to assign second part-of-speech tags to the second plurality of tokens;
performing a lemmatization of the second plurality of tokens using the second part-of-speech tags to determine root words for the second plurality of tokens; and
searching the index using the root words determined for the second plurality of tokens.

20. The computer program product of claim 14, wherein the computer-executable instructions further comprise instructions executable for:
receive a plurality of tokens generated from a search query;
execute the optimized computer code to assign part-of-speech tags to the plurality of tokens;
perform a lemmatization of the plurality of tokens using the part-of-speech tags to determine root words for the plurality of tokens; and
search an index using the root words.

21. A computer-implemented method comprising:
receiving a first plurality of tokens generated from a document to be indexed;
executing optimized computer code to assign first part-of-speech tags to the first plurality of tokens, the optimized computer code embodying ripple down rules generated by a machine learning ripple down rules generator;
performing a lemmatization of the first plurality of tokens using the first part-of-speech tags to determine root words for the first plurality of tokens; and
indexing the document, indexing the document comprising adding the root words determined for the first plurality of tokens to an index.

22. The computer-implemented method of claim 21, further comprising:
receiving a second plurality of tokens, the second plurality of tokens generated from a search query;
executing the optimized computer code to assign second part-of-speech tags to the second plurality of tokens;
performing a lemmatization of the second plurality of tokens using the second part-of-speech tags to determine root words for the second plurality of tokens; and
searching the index using the root words determined for the second plurality of tokens.
